(19) United States
(12) Patent Application Publication
(10) Pub. No.: US 2022/0188870 A1
(43) Pub. Date: Jun. 16, 2022

(54) DISPLAY UNIT WITH AN IDENTIFICATION ELEMENT SUITABLE FOR PRESENTING ONE OR MORE PRODUCTS

(71) Applicant: Conex Digital LLC, Melville, NY (US)

(72) Inventors: Louis Dupere, Mamaroneck, NY (US); Nicolas Lorin, Stony Brook, NY (US); Jean Vieville, New York, NY (US); Waqas Nadeem, New York, NY (US); Nikit Khandagale, Hicksville, NY (US)

(21) Appl. No.: 17/644,273

(22) Filed: Dec. 14, 2021

(30) Foreign Application Priority Data
Dec. 16, 2020 (FR) 20 13356

(51) Int. Cl. G06Q 30/02; G06V 40/16; G06V 20/52; G06K 19/07; G06K 19/06

(52) U.S. Cl. CPC G06Q 30/0268; G06V 40/161; G06K 19/06037; G06K 19/0723; G06V 20/52

(57) ABSTRACT

A sales display unit (12A) adapted to present one or more products (32), comprising at least one module (36, 38) for displaying a set of products (48), and a processing unit comprising a processor and a memory, the module comprising:
a receptacle (50) comprising a detection member (68), and
a product support (52) and an identification member (84).

The detection member is adapted to cooperate with the identification member to identify the product support, and to send the processing unit information representative of the identified product support being in an installed position, the memory comprising information which, when executed by the processor, causes the processing unit to send information relating to the product set to a server and/or screen (76A).

### BACKGROUND OF THE INVENTION

### Field of the Invention

The present invention relates to a display unit adapted to present one or more products, in particular cosmetics, and to advertise the product(s) at a point of sale, the display unit comprising at least one module intended to present at least one set of products, the display unit comprising a frame.

The invention also relates to a method of presenting one or more products to advertise the product(s) at a point of sale, using such a display unit.

### Description of Related Art

A cosmetic product is preferably a product as defined in the EC Regulation No. 1023/2009 of the European Parliament and of the Council of 30 Nov. 2009 on cosmetic products.

Such display units are usually found in various numbers at the point of sale and take various forms adapted to the products: Counter displays, drawer systems, wall systems, gondola shelving, etc. Each display unit is used to showcase one or more sets of products, usually corresponding to product families. The cosmetic product sets are presented in dedicated modules of the display unit for a certain period of time.

In order to manage the presentation of the products, a distribution plan, or “planogram”, of the display unit is used, i.e. a presentation, generally visual, of the layout of the products in the display unit. This “planogram” provides a list of products and their locations. For example, paper strips can be applied to the display unit to indicate product characteristics, including prices. “Planograms” are usually managed upstream by the product suppliers (the brands attached to the products) and typically change up to four to six times a year, depending on the season, fashion, etc.

Such display units, organised by “planograms”, are generally satisfactory, but their management remains complex and depends on the availability and goodwill of the staff who install them. The number of changes per year is effectively limited to four to six. In addition, there are risks of errors in the presentation of products: Obsolete products may be left in place, or incorrect prices may be displayed, with the legal consequences attached to this type of error. Trademarks must therefore assume that the “planograms” are being followed, but have no assurance that this is actually the case.

Furthermore, in the area of point-of-sale display units, the use of digital means is considered “unmanageable” by wifi or USB.

The need to modify the digital screen via a USB protocol involves a lengthy set-up process (preparing a USB key, sending it by post, installing it in the shop, restarting the display unit) and does not allow the brand to verify the availability of new content that the salesperson(s) may not have put in place.

The implementation of content changes via wifi implies that the brand will have to obtain access to the in-store wifi infrastructure of each of their distribution networks (supermarkets, specialised shops, airport terminal shops, etc.). This would involve the brand negotiating with each distribution network to set up a data network in several thousand shops, which is not a solution that would be scalable.

Cameras are sometimes used to recognise the arrangement of products on shelves. However, this solution is imperfect and the point of sale does not always allow sufficient distance for the camera(s) to view the entire display unit, or all of them.

Similarly, LCD screens, especially in 3-inch size, are sometimes used in display units.

Generally speaking, the above-mentioned means do not solve the problems of complexity and compliance with “planograms” and have the disadvantage of requiring a significant amount of labour not only prior to arrival in the shop, but also when installing updates in the shop.

One aim of the invention is therefore to provide a display unit that facilitates the implementation of “planograms” and their automation of in a programmatic manner. Currently, setting up and changing graphics (visuals, price or product labels) is a manual process that involves printing a graphic, sending it by post, and having an installer or salesperson set it up. This process can take several weeks or months and involves complex, large-scale logistics. Also, this process does not guarantee the implementation of the remote graphic change, as one of the links in the installation chain may be faulty (wrong installer, no graphic, printing error, etc.). Furthermore, the installation of a remote graphic change does not guarantee that it has been done according to the brand's strategic choices (failure to position a product on a display unit, incorrect installation of a visual, etc.).

### BRIEF SUMMARY OF THE INVENTION

To this end, the object of the invention is a sales display unit adapted to present one or more products, in particular cosmetics, and to advertise the product(s) at a point of sale, the display unit comprising at least one module intended for the presentation of at least one set of products, the display unit comprising a frame, at least one processing unit comprising a processor and a memory, the module comprising:
optionally a reserve containing a stock of said set of products,
a receptacle mounted on the frame and comprising a detection member, and
a product support comprising an identification member representative of the product support, the product support being movable between an uninstalled position, in which the product support is away from the receptacle, and an installed position, in which the product support is received in the receptacle,
the detection member being adapted to cooperate with the identification member, when the product support is in the installed position, to identify the product support, and to send to the processing unit information representative of the identified product support being in the installed position,
the memory comprising information which, when executed by the processor, causes the processing unit to send information contained in the memory to a server via a network, and/or to a screen of the display unit, the information sent relating at least to the set of products associated with the identified product support.

According to particular embodiments, the display unit has one or more of the following features taken in isolation or in any combination that is technically possible:

the product support comprises at least one sample product associated with the product set;

the product support comprises at least one display product associated with the product set;

the identification element comprises: a radio tag, a QR code, or an analog electrical circuit;

the memory further comprises information which, when executed by the processor, causes the processing unit to:
read at least one piece of information from the memory, and send the read piece of information to the server, the read piece of information being related to the set of products associated with the identified product support, or representative of the identified product support being in the installed position, and/or
send a request to the server for information about the set of products associated with the identified product support, and/or for configuration information of the processing unit, receive said information, and write it into the memory;

the display unit further comprises at least one sensor adapted to perform facial detection of a user of the display unit, and/or a sensor for tracking said stock by visual recognition of products in said stock;

the receptacle comprises a fixed part integral with the frame, a drawer mounted movably on the fixed part, and a sensor adapted to detect an opening or closing of the drawer and send information representative of the opening or closing to the processing unit;

the memory comprises information which, when executed by the processor, causes the processing unit to:
read new video information from the memory, and send the new information to the screen, the new information being related to the product set associated with the identified product support, or
send the server information representative of the opening or closing;

the display unit comprises a geolocation system adapted to geolocate the display unit and provide the processing unit with geolocation information, or an interface allowing a user of the display unit to provide the processing unit with geolocation information;

the display unit comprises a button connected to the processing unit, the processing unit being configured to display information representative of the display unit on the screen when the button is operated by a user of the display unit;

the display unit comprises a plurality of modules for the presentation of a plurality of product sets, each of the modules comprising:
optionally a reserve containing a stock of said set of products,
either a decentralised processing unit with a processor and memory, or a video management chip connected to the display unit's central processing unit,
a screen connected to the decentralised processing unit or to the chip,
a receptacle mounted on the frame and comprising a detection member, and
a product support comprising at least one sample product associated with one of the sets of products, the product support comprising an identification member representative of the product support, the product support being movable between an uninstalled position, in which the product support is away from the display unit, and an installed position, in which the product support is received in the receptacle,
the detection member being adapted to cooperate with the identification member, when the product support is in the installed position, to identify the product support, and to send to the decentralised processing unit, or to the processing unit of the display unit, information representative of the identified product support being in the installed position,
the memory of the decentralised processing unit or of the display unit's processing unit including information which, when executed by the processor of the decentralised processing unit or the display unit's processing unit, causes the decentralised processing unit or the display unit's processing unit to send video information contained in the memory to the screen, the video information relating to the set of products associated with the identified product support;

the display unit comprises a module intercommunication system adapted so that the decentralised processing units or the display unit receive positioning information:
representative of the relative position to each other of receptacles having product supports in the installed position, and/or
for each of the receptacles having product supports in the installed position, representative of the product supports that are in the installed position in those of the receptacles located in a predefined vicinity of each of the receptacles;

the memory of the display unit's processing unit or of at least one of the decentralised processing units comprises information which, when executed by the processor of the display unit's processing unit or of the at least one of the decentralised processing units, leads the display unit's processing unit or the at least one of the decentralised processing units to:
send the server the said positioning information, and/or
send synchronised video information to some of the screens; and

the memory of at least one of the decentralised processing units associated with one of the receptacles comprises information which, when executed by the processor of the at least one of the decentralised processing units, leads the at least one of the decentralised processing units to:
send information to another of the decentralised processing units, or
send the screen associated with it information relating to one of the product sets associated with one of the product supports received in another of the receptacles.

The invention also relates to a method of presenting one or more products, in particular cosmetics, at a point of sale in order to advertise the product(s) at the point of sale, using a display unit, and comprising the following steps:
moving the product support from the uninstalled position to the installed position,
cooperation of the detection member with the identification member to identify the product support, and to send to the processing unit information representative of the identified product support being in the installed position,
reading, by the processor, of information from the memory, and
sending by, the processing unit, of information contained in the memory to the server via the network, and/or to the screen, the information relating at least to the set of products associated with the identified product support.

### BRIEF DESCRIPTION OF THE SEVERAL VIEWS OF THE DRAWING(S)

The invention will be better understood upon reading the following description, given only as an example, and with reference to the attached drawings, in which:

FIG. 1 is a schematic view illustrating the remote management of a plurality of display units according to the invention,

FIG. 2 is a perspective view of a display unit according to a first embodiment of the invention, with the product supports not shown, and of an interface for communication with the server,

FIG. 3 is a perspective view of one of the modules of the display unit shown in FIG. 2,

FIG. 4 is a perspective view of one of the product supports of the display unit shown in FIG. 2,

FIG. 5 is a schematic view of the display unit shown in FIG. 2,

FIG. 6 is a schematic view of a display unit according to a second embodiment of the invention.

### DETAILED DESCRIPTION OF THE INVENTION

Installation and Networks

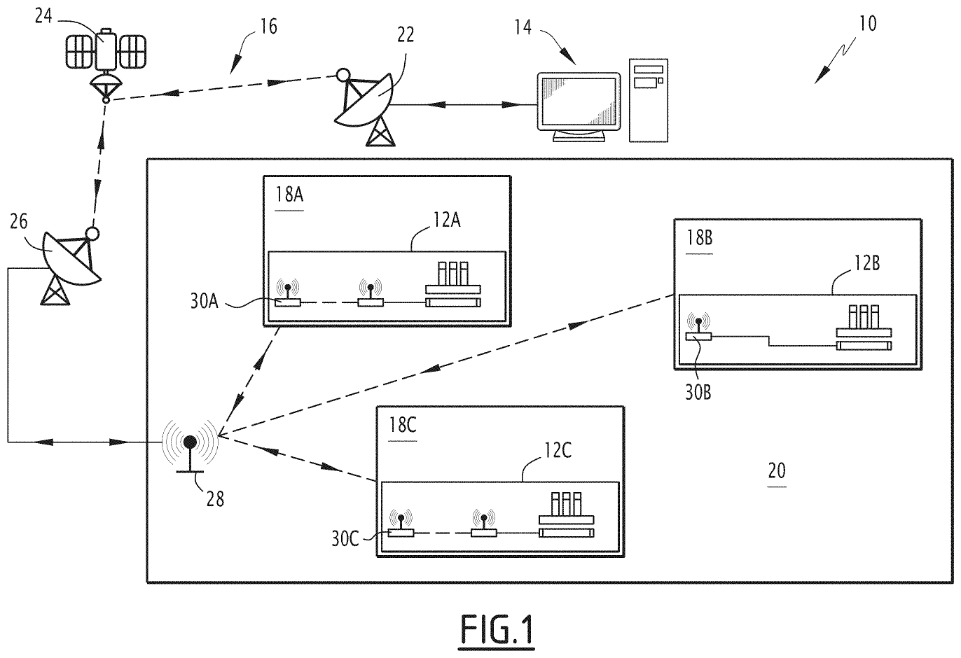

With reference to FIG. 1, an installation 10 comprising a plurality of display units 12A, 12B, 12C according to the invention is described. The installation 10 further comprises a server 14, for example a remote server, connected to each of the display units 12A, 12B, 12C by a network 16.

The display units 12A, 12B, 12C are respectively located in points of sale 18A, 18B, 18C, for example cosmetics shops, or portions dedicated to the sale of products, in particular cosmetics, in larger commercial spaces (not shown).

According to a variant not shown, the points of sale 18A, 18B, 18C comprise more than one display unit according to the invention.

In the example shown, the points of sale 18A, 18B, 18C are located in the same country 20.

According to a variant not shown, the points of sale 18A, 18B, 18C are located in several different countries.

In the example, server 14 is located in yet another country.

The network 16 comprises for example at least one telecommunication antenna 22 connected to the server 14, and at least one satellite 24 adapted to communicate with the telecommunication antenna 22. The network 16 further comprises at least one telecommunication antenna 26 located in the country 20 and adapted to communicate with the satellite 24 and connected to a relay antenna 28.

Communication via the network 16 is advantageously bidirectional (from the server 14 to the display units 12A, 12B, 12C).

The relay antenna 28 is adapted to communicate with antennas 30A, 30B, 30C of the display units 12A, 12B, 12C, for example via a 3G/4G protocol.

Obviously, in FIG. 1, the network 16 is shown in a simplified form, with two telecommunication antennas 22, 26, and one relay antenna 28. In reality, the network 16 may be more complex, in a manner known per se to those skilled in the art of national and international telecommunications, including a greater number of interchangeable antennas.

Display Units

The display unit 12C is for example identical to the display unit 12A and will not be described.

The display unit 12B is almost identical to the display unit 12A and will be briefly described below.

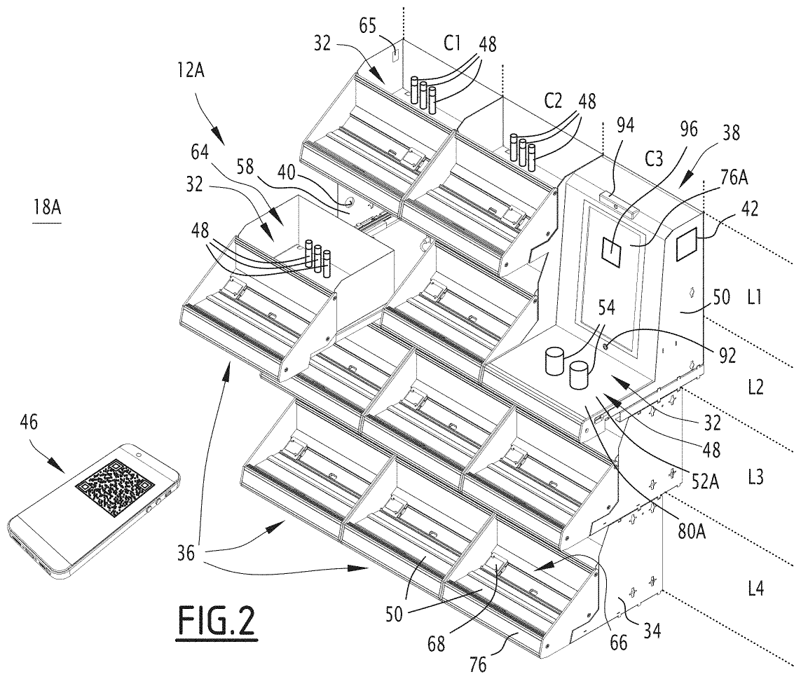

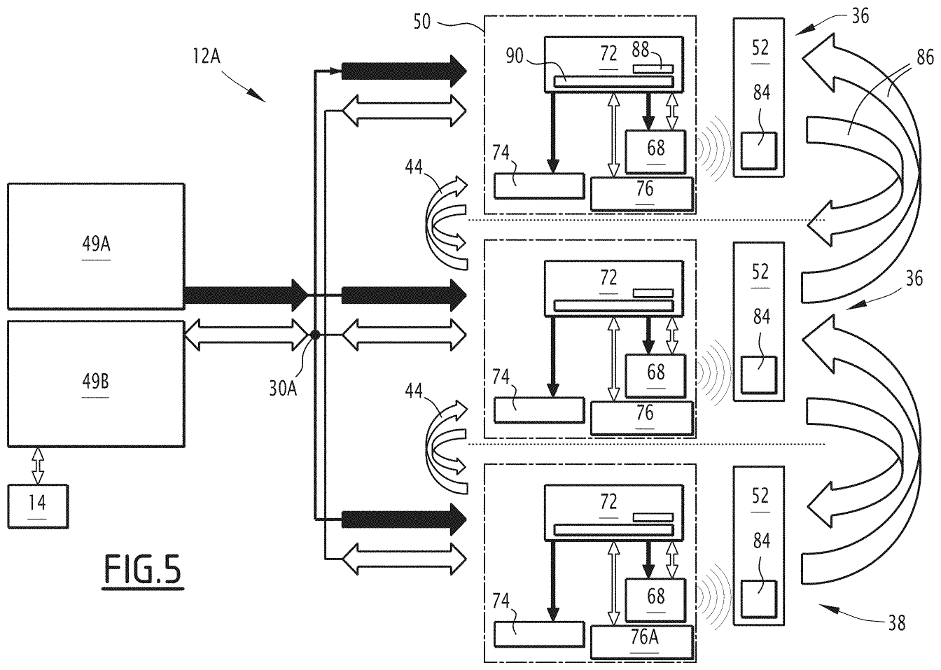

Only the display unit 12A will be described hereafter in detail, rather with reference to FIGS. 2 to 4 for structural aspects, and rather with reference to FIG. 5 for functional aspects.

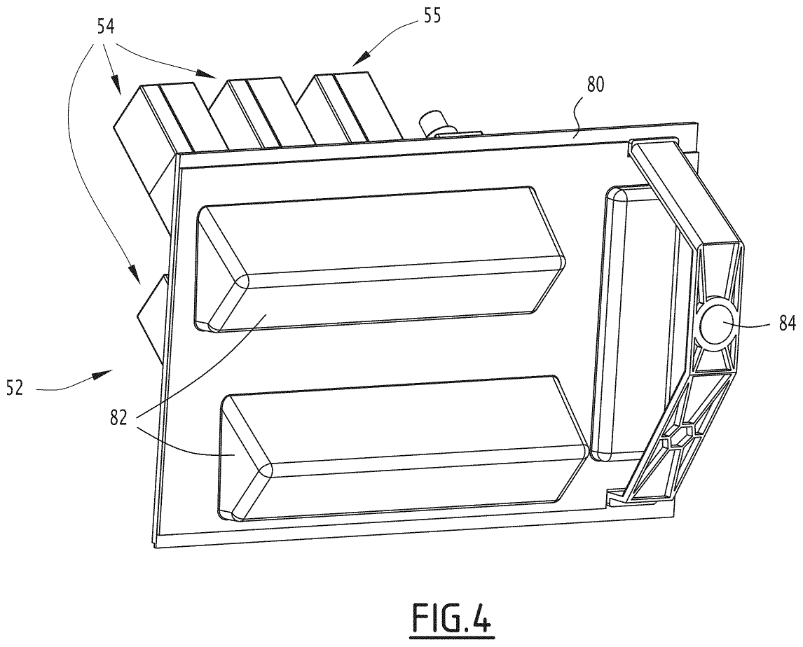

The display unit 12A is adapted to present one or more products 32, in particular cosmetics, part of which is visible in FIG. 4, and to advertise the product(s) 32 at the point of sale 18A.

The display unit 12A comprises a frame 34, a plurality of modules 36 attached to the frame and advantageously similar to each other, and for example a module 38 slightly different from the modules 36 that is also attached to the frame.

In the example shown, the display unit 12A is of the “drawer system” type, with the frame 34 being free-standing and rather vertical, with the modules 36 forming drawers as will be seen.

According to variants not shown, the display unit 12A belongs to another type, for example a wall system in which the frame 34 is fixed to a wall (not shown), a gondola shelving unit, a counter display, or other types of display units known per se.

Advantageously, the display unit 12A includes a “hidden” button 40, for example mounted on the frame 34 in an inconspicuous place, and a geolocation system 42 also mounted on the frame.

The display unit 12A comprises, for example, an intercommunication system 44 adapted to allow the modules 36 to communicate with each other and advantageously with the module 38, in a manner to be described below.

Advantageously, the display unit 12A comprises an interface 46 allowing a user (not shown) of the display unit to send information relating to the display unit to the server 14, for example geolocation information of the display unit, or to receive information.

In a particular embodiment not shown, the display unit 12A comprises only one module, particularly if it is a counter display unit.

Modules

Each of the modules 36, 38 is respectively intended for the presentation of a set of products 48 corresponding to a sub-group of the products 32 presented by the display unit 12A.

In the example shown, there are ten modules 36 (FIG. 2), of which only two are shown in FIG. 5. The modules 36 are, for example, arranged in rows or arrays above each other and marked L1 to L4 in FIG. 2, and in columns C1 to C3.

In the example, there are four rows and three columns. The bottom rows L3 and L4 each have three modules 36. The top rows L1 and L2 have two modules in columns C1 and C2 respectively.

Module 38 occupies column C3 and rows L1 and L2. In the example, module 38 occupies a space corresponding in volume to two spaces of the modules 36.

In display units 12A and 12C, modules 36, 38 are connected to antennas 30A and 30C respectively by a wireless network, while in display unit 12B, modules 36, 38 are connected to antenna 30B by wires.

As the modules 36 are similar, only one of them will be described below. The differences between the module 38 and the modules 36 will be described later.

Each of the modules 36 is connected to a power source 49A and to the internet network 49B.

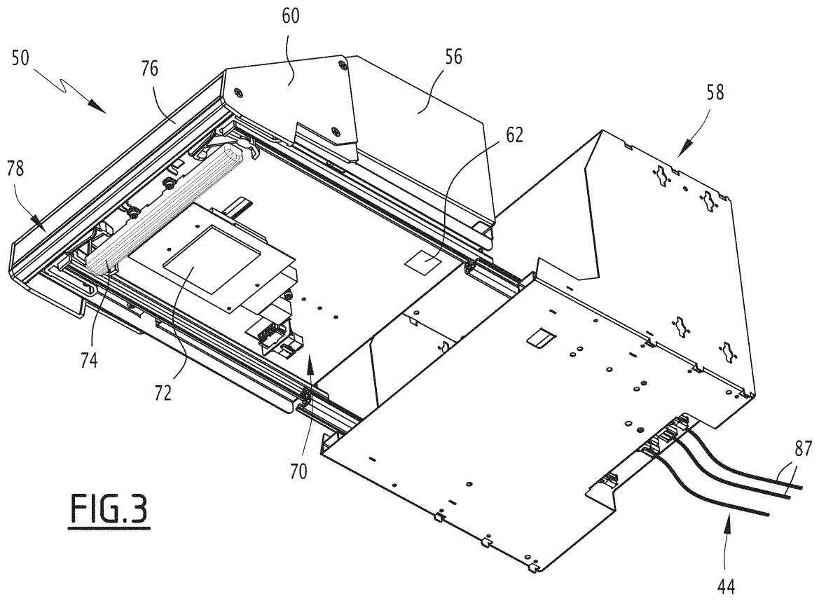

Each of the modules 36 comprises a receptacle 50 (FIG. 3) mounted on the frame 34, a product support 52 (FIG. 4) comprising for example sample products 54 associated with the module's product set 48 (stock), and advantageously a reserve 56 adapted to receive a stock of said product set 48.

The products 48 are usually packaged products.

Sample products 54 are not for sale. They are intended to allow a potential customer (not pictured) to try out one or more products representative of the product set 48.

In the example shown, the receptacle 50 comprises a fixed part 58 integral with the frame 34, a drawer 60 movably mounted on the fixed part, and a sensor 62 adapted to detect an opening of the drawer relative to the fixed part.

The reserve 56 is, for example, fixed to the rear of the drawer 60 relative to the display unit 12A. The reserve 56 forms, for example, a parallelepipedic housing 64 open towards the top of the display unit 12A. Advantageously, the reserve 56 comprises a sensor 65 for monitoring said stock, for example an infrared sensor, adapted to perform a visual recognition of the products present in the reserve.

According to one particular embodiment, the reserve 56 is absent (the module does not have a reserve), as is the case for the module 38 for example. In this case, the module concerned is purely a module for presenting sample products 54. If a customer wants to buy one of the products shown, that customer will, for example, approach a salesperson (not shown).

The drawer 60 defines an upper housing 66 which is open upwards and advantageously towards the front of the display unit 12A. The drawer 60 includes a detection member 68, for example located at the bottom of the upper housing 66. For example, on a lower side 70, the drawer 60 comprises a decentralised processing unit 72, and a light source 74 adapted to illuminate one of the modules 36 below. Advantageously, the drawer 60 comprises a screen 76 connected to the processing unit 72 and forming, for example, all or part of a front face 78 of the drawer.

In a variant not shown, the display unit does not have a screen.

The screens 76 of the modules 36 located on the same line are for example in horizontal continuity with each other.

Alternatively, or in addition to the sample product(s) 54, the product support 52 comprises one or more display product(s) 55 (FIG. 4) associated with the product set 48 of the module.

The display product(s) 55 are not intended for sale. They are intended to provide a potential customer (not shown) with visual and/or audio information about the products 48 in the module.

For example, the display product 55 is a medium with printed information or a printed image.

In another embodiment (not shown), the product support 52 is free of sample products 54 and display products 55.

The product support 52 comprises a holder 80 advantageously forming a housing or housings 82 for the sample products 54 and/or for the display product(s) 55, and an identification member 84 representative of the product support.

The identification member 84 is fastened to the holder 80.

In an alternative embodiment not shown, the display product(s) 55 forms a printed image(s) extending into the housing(s) 82.

The product support 52 is movable between an uninstalled position (FIG. 4), in which the product support is away from the receptacle 50, and an installed position (shown in FIG. 5), in which the product support is received in the upper housing 66 of the receptacle.

The product supports 52 are advantageously interchangeable, in that they can be placed in any of the receptacles 50 of the modules 36. This is symobilised by arrows 86 in FIG. 5.

When the product support 52 is devoid of sample products 54 or display products 55, i.e. empty, its presence in the installed position is nevertheless detected by the identification member 84.

Advantageously, the holder 80 has a shape complementary to that of the receptacle 50, giving stability to the product support 52 in the installed position.

In the installed position, the identification member 84 is within detection range of the detection member 68.

The identification member 84 is for example an RFID tag or a Near Field Communication (NFC) sensor.

In variants not shown, the identification member 84 is a QR code, or an analogue electrical circuit.

The detection member 68 is connected to the processing unit 72. The detection member 68 is adapted to co-operate with the identification member 84 when the product support 52 is in the installed position, to identify the product support, and to send to the processing unit 72 information representative of the identified product support 52 being in the installed position.

When the identification member 84 is an analogue circuit, the detection member 68 has connectors (not shown) adapted to cooperate with the identification member to create closed low-voltage circuits representative of the product support 52.

The sensor 62 is, for example, an accelerometer attached to the drawer 60, or a distance sensor between the drawer and the fixed part 58 of the receptacle 50. The sensor 62 is connected to the processing unit 72 and adapted to send it information representative of the opening of the drawer.

Alternatively, the sensor 62 is adapted to send information representative of the closing of the drawer 60.

The geolocation system 42 is adapted to geolocate the display unit 12A and to provide the processing unit 72 with geolocation information. The geolocation system 42 comprises, for example, a GPS chip (not shown) or a cellular system adapted to indicate to the server 14 the nearest cell towers and the bandwidth related to each of the towers, and thereby enable a position of the display unit to be calculated by triangulation of neighbouring cell towers (not shown, but such as antenna 28).

The intercommunication system 44 is advantageously adapted so that the processing units 72 of the display unit 12A receive positioning information:

representative of the relative position to each other of receptacles 50 having product supports 52 in the installed position, and/or

for each of the receptacles 50 having product supports 52 in the installed position, representative of the product supports 52 that are in the installed position in those of the receptacles 50 located in a predefined vicinity of each of said receptacles.

The intercommunication system 44 comprises, for example, cables 87 connecting neighbouring modules 36, 38 to each other, or optionally wireless (e.g. magnetic) connectors providing communication between the different neighbouring sets 36 and 38.

For example, the predefined vicinity is provided by one-way, or optionally two-way, communication with the four nearest neighbouring modules (e.g. the ones on the top, bottom, right, and left). The communication between these four nearest neighbours allows the module 36 or 38 to recognise the presence or absence of a neighbour. If there is a neighbour, it exchanges its unique identity defined by the set 72 as well as its relative position (e.g. top, bottom, right, or left). In fact, the set of relationships allows the relative position of modules 36 and 38 to be established dynamically and autonomously in relation to each other.

Processing Units

The processing unit 72 of each module 36, 38 comprises a processor 88 and a memory 90. The processing unit 72 is adapted to communicate over the Internet via the network 16 with the server 14.

The memory 90 comprises information which, when executed by the processor 88, advantageously causes the processing unit 72 to send information, for example video, contained in the memory to the screen 76, the information relating to the product set 48 associated with the identified product support 52.

Advantageously, the memory 90 further comprises information which, when executed by the processor, causes the processing unit 72 to:

read at least one piece of information from the memory, and sending the read information to the server 14, the read information being related to the set of products 48 associated with the identified product support 52, or representative of the identified product support 52 being in the installed position, and/or

send a request to the server 14 for information about the set of products 48 associated with the identified product support 52, and/or for configuration information of the processing unit 72, receive said information, and write it into the memory.

According to one particular embodiment, the memory 90 comprises information which, when executed by the processor 88, causes the processing unit 72 to:

if information representative of the opening of the drawer 60 is received, reading new video information from the memory, and send the new video information to the screen 76, the new video information being related to the product set 48 associated with the identified product support 52, or

send information representative of the opening to the server 14.

Even more advantageously, the memory 90 of the processing unit 72 comprises information which, when executed by the processor 88, leads the processing unit 72 to:

send the server 14 the said positioning information, and/or

send synchronised video information to some of the screens 76; and

According to one particular embodiment, the memory 90 of at least one of the processing units 72 associated with one of the receptacles 50 comprises information which, when executed by the processor 88 of the at least one of the processing units, causes the at least one of the processing units 72 to:

send information to another of the processing units 72, or

send the screen 76 associated with it information relating to one of the product sets 48 associated with one of the product supports 52 received in another of the receptacles 50.

Module 38

The module 38 is functionally similar to the modules 36 but differs slightly structurally.

As already mentioned, according to one particular embodiment, the module 38 does not comprise a product reserve.

The holder 80A of the product support 52A forms a tray. The screen 76A is located behind the product support 52A as seen by an observer (not shown) in front of the module 38.

The module 38 comprises one or more cameras 92 adapted to recognise the sample products 54 present on the holder 80A, as explained for example in U.S. Pat. No. 10,643,270.

Advantageously, the module 38 comprises a facial recognition system 94 for a customer (not shown) located in front of the module 38.

The system 94 is advantageously able to recognise specific human attributes such as face, gender, age, gaze position, face position in space, body position (tracking of arms, legs), and to estimate the activity of the customer (purchasing, walking, product observation, oral communication with a salesperson, etc.). The information obtained by the system 94 is for example stored in the processing unit 72 of the module 38.

The visual recognition of the person(s) can be done via a specific processing unit dedicated to facial recognition by an artificial intelligence embedded in the processing unit. This processing unit is, for example, specifically programmed to recognise people quickly and their presence around the display unit. The analysis will be able to take place locally in the display unit directly without having to send an image of the person via a telecommunication network thanks to the use of a dedicated artificial intelligence chip.

For example, the button 40 is connected to the processing unit 72 of the module 38, that processing unit being configured to display information representative of the display unit on the screen 76A when the button is activated by a user of the display unit.

The information in question is, for example, a QR 96 code.

The interface 46 is, for example, a terminal or mobile phone adapted to read that information on the screen 76A.

The operation of the display unit 12A will now be described.

Recognising a Product Support 52

For example, to achieve a “planogram”, a user of the display unit 12A, typically an employee of the point of sale 18A, places the various product supports 52, 52A in their installed position in the receptacles 50 of the modules 36, 38, in accordance with the “planogram”.

For each of the modules 36, 38 that has received a product support 52, 52A, the detection member 68 of the module cooperates with the identification member 84 of the product support to identify the product support, and to send information to the processing unit 72 representative of the identified product support being in the installed position.

The processor 88 reads information from the memory 90 and the processing unit 72 sends video information from the memory to the screen 76, 76A relating to the product set 48 associated with the identified product support 52.

The video information is advantageously already present in the memory 90.

Alternatively, the video information to be displayed is obtained from the server 14 via the network 16. To do this, the processing unit 72 sends the server 14 a request for information about the product set

48 associated with the identified product support 52, receives said information and writes it into the memory 90.

Thus, the information displayed by each of the screens 76, 76A respectively is consistent with the product sets 48 and the sample products 54 actually presented by each of the modules.

Information Reporting

The processing unit 72 of the modules 36, 38 reads at least one piece of information from the memory 90, and sends the read information to the server 14, the read information being related to the set of products 48 associated with the identified product support 52, or representative of the identified product support 52 being in the installed position.

The information is retrieved via network 16. This network is wireless, for example 3G/4G.

In a variant not shown, the network is wired, for example ADSL, or fibre. According to another variant not shown, the network is satellite-based, or alternatively at least partly wire-based.

The information is, for example, stored dynamically (in real time) in each processing unit 72, and saved as computer language.

For security reasons, a technology for encoding this information is advantageously used.

The transfer of information via a 3G/4G network with on-board connectivity in the display unit 12A has the advantage for the brand that it does not have to negotiate network access with the managers of the points of sale 18A, 18B, 18C.

Thus, the display units 12A, 12B, 12C can be completely independent from the networks of these managers and put in a secure network (private 3G/4G network, VPN tunnel, etc.).

If the drawer 60 of one of the modules 36 is opened, the sensor 62 sends information to the processing unit 72 representative of this opening. This information is advantageously stored locally in the memory 90. That information is, for example, processed locally by the processing unit 72 to calculate an opening number or time and then sent to the server 14, or sent without processing.

The facial recognition system 94 recognises the aforementioned specific human attributes of the customer (not shown), and estimates the customer's activity (e.g. one or more of shopping, walking, observing sample products 54, speaking to a salesperson, etc.). The measured information is stored in the processing unit 72 of the module 38 and then sent, pre-processed or not, to the server 14.

Each of the sensors 65 of the modules 36 with a stock in the reserve 56 performs a visual recognition of the products present in the reserve, and transmits the collected information to the processing unit to which it is connected.

The visual recognition of the product(s) can be done via a specific processing unit dedicated to product recognition by an artificial intelligence embedded in the processing unit. For example, this processing unit is specifically programmed to quickly recognise products and their presence on the display unit's storage area. The analysis may take place locally in the display unit directly without having to send an image of the person, via a telecommunication network thanks to the use of a dedicated artificial intelligence chip.

The camera 92 of the module 38 recognises the sample products 54 present on the holder 80A and sends corresponding information to the processing unit 72 of the module 38.

Relative Positions of the Modules

The intercommunication system 44 sends the processing units 72 of the display unit 12A positioning information representative of the relative position to each other of the receptacles 50 having product supports 52 in the installed position.

For each of the receptacles 50 having product supports 52 in the installed position, the information sent is advantageously representative of the product supports 52 that are in the installed position in those of the receptacles 50 located in a predefined vicinity of each of said receptacles.

The intercommunication system 44, together with the processing units 72, allows each of the modules 36, 38 to recognise its nearest neighbour(s).

For example, for a multi-module display unit such as 12A, for each of the modules, all of the modules around it (360 degrees) are recognised, along with their unique identity.

The modules 36, 38 use this information shared between them to reconstruct the constitution and positioning of each other dynamically (in real time) and use this information in the management of cases (illustrated below) or in the synchronous distribution of video information. To identify the position of one of the modules relative to another, a module coordinate system is used, such as that defined by rows L1 to L4 and columns C1 to C3.

Triggering Actions when Setting Up Product Supports 52

Advantageously, the display unit 12A comprises a case manager that allows it to manage different steps resulting from a customer's interaction with the display unit.

For example, the display unit 12A is pre-configured with these scenarios so that it knows how to respond to the interactions occurring at the point of sale 18A. This configuration is stored in the memory 90 and can be changed remotely.

This case manager is at the centre of the communications between the various software packages advantageously present in the processing units 72 and has the objective of properly translating a message received from a sensor, analysing it, and performing the corresponding actions.

For example, when the opening of the drawer 60 of one of the modules 36 is detected, the relevant processing unit 72 receives the information representative of the opening, reads new video information contained in its memory 90, and sends the new video information to the screen 76, the new video information relating to the set of products 48 associated with the product support 52 placed in the module whose drawer has just been opened. In other words, the video displayed on the module's screen 76 adapts to the fact that the drawer 60 has just been opened.

According to one particular embodiment, the processing unit 72 of the module whose drawer 60 has just been opened sends information to another of the processing units 72, so that the module corresponding to that other processing unit performs an action such as, for example, turning off or dimming the light 74, or displaying a particular video content.

The communication between the different modules 36, 38 of the display unit 12A is carried out by wired or wireless means, using protocols known per se.

Geolocation of Product Supports 52 and Display Units to Receive Specific Information

The geolocation system 42 geolocates the display unit 12A and provides the processing units 72 with geolocation information, also received by the server 14.

This information can be used to identify, for example, the country 20 in which the display unit 12A is located. Based on this information, the server 14, which has access to information on prices charged at the point of sale 18A (by the retailer or the brand), sends that information dynamically to each of the modules 36, 38 according to the product supports 52, 52A installed in the receptacles 50.

Alternatively, the location of the display unit 12A is entered manually, for example during the installation of the display unit, using the interface 46, via a mobile application or a website. To do this, the user scans a code on the display unit, for example the QR 96 code, or on the display unit's packaging, and indicates the address where the display unit is installed via a graphic interface.

Detecting a Product Support in a Display Unit Containing Other Product Supports—Exact Location of the Product Support in a Display Unit

Thanks to the intercommunication system 44, each module 36, 38 is informed of the relative position of some of the modules with respect to it. Advantageously, each module knows dynamically which product supports 52 are in its immediate environment. The retrieval of information concerning the carriers of neighbouring products makes it possible, for example, to inform the brand in real time about the organisation of cosmetic products at the point of sale 18A.

In addition, the communication established between the different modules allows the customer to be informed about the products present in a local environment. Similarly, the brand can inform the staff at the point of sale 18A of the correct procedure to follow in order to follow the “planogram”.

Triggering Synchronised Actions

The processing unit 72 sends synchronised video information to some of the screens 76.

For example, if a customer takes a product A from a first module of the modules 36, 38, and this product is likely to be used in combination with a product B present on a second module, the processing unit 72 of the first module sends information to the processing unit of the second module so that, for example:

the light source 74 of the second module is triggered, and/or

video information about product B is displayed on the screen 76, 76A of the second module.

Advantageously, the processing unit 72 of one of the modules sends synchronised video information to some of the screens 76. This allows video content to be synchronised and so-called ‘extended content’ to be created. To do this, extended content passing through all the module screens and respecting the relative positioning of one module to another is cut out and distributed to each screen individually and synchronously. In particular, two methods of synchronising individual content are possible: Active or passive.

In active synchronisation, where the modules communicate in real time with their neighbours in the network (wireless or wired), one of the modules acts as the master, and tells the others, the slaves, what to do. The master sends the slaves the exact position of the video content it is currently displaying, as well as the content it is currently displaying. Slaves are responsible for following the master and ensuring that they are on the same frame of the video playing on the master's screen 76 or 76A. If one of the slaves is one or more frames ahead or behind, it passes these frames to the master to wait or speed up.

If the master is no longer in the network, another master is designated in the network. At start-up, the position of the master is defined in the network (e.g.: Master position is at C1). This positioning takes place at start-up once the dynamic positioning process has been carried out (relative positions of one set 36 to another) and after checking that the modules in the network are in a position equivalent to the previous/historical positioning. If the master is lost while a set of modules is in use, another master is automatically chosen to ensure that all slaves act according to the procedure.

In passive synchronisation, the modules do not communicate directly with each other in a local network, but via an external telecommunication network, e.g. 3G/4G. The management of the positioning of the video sequences is carried out in the server 14 and each module synchronises itself individually. Each module receives the exact moment when a particular sequence of video content should be played. Thus, when the processing unit 72 downloads the video content from the server 14, it also downloads the synchronisation commands or orders that will allow it to be in sync with its close neighbours without needing to intercommunicate with them in a local network. In order to manage this synchronisation, the local time of the display unit matches among the different elements of the system, so that the synchronisation preset by the server is correct and accurate, and the synchronisations of the video sequences correspond between the different modules 36 and 38.

The distribution of specific contents to each screen 76, 76A is advantageously linked both to the relative positioning established beforehand, and also to the product supports 52 actually received in each of the receptacles 50.

Remote Content Updating

The processing unit 72 of a module sends a request to the server 14 for information about the set of products 48 associated with the identified product support 52, and/or configuration information for the processing unit 72. The processing unit 72 receives this information and writes it into the memory 90.

The connection to the server 14 is made via a local network (Wifi/Bluetooth) or external network (3G/4G). Each module pre-loads its memory 90 with the content required for the use of the module and the management of use cases (for example: what to do when a drawer opens, etc.).

Alternatively, the contents are downloaded in real time when one of the product supports 52 is moved to the installed position (i.e. is placed in the receptacle 50).

For example, if a brand wishes to send a new product support 52, the unique identification member 84 is recognised by the identification member 68 of the receptacle 50 in which the new product support is placed.

When the product support 52 is set up, either the video content relating to the set of products 48 corresponding to the product support is already present in the memory 90 of the module concerned and is displayed directly, or the content has not been loaded and the module automatically downloads the content to its memory via the network set up in the point of sale.

Remote Module Maintenance

The processing unit 72 sends a request for processing unit 72 configuration information to the server 14, receives said information and writes it to the memory 90.

In this way, maintenance operations can be carried out remotely, for example updating content, modifying case studies/experiences in the shop, managing the brightness of the screens, etc. In addition, it is possible to indicate to the staff at the point of sale if a product support 52 is incorrectly placed or needs to be removed in order to adhere to a “planogram”.

Remote Checking of the Number of Openings and Closings of a Module—Preventive Stock Management

As explained above, the number of openings and/or closings of the drawer 60 is known. Thanks to this information transmitted to the server 14, it is possible, for example, to send the brand an estimate of the use of the drawer 60 of each of the modules, and also of the profitability of this or that product 32 corresponding to one of the product supports 52.

Thanks to the sensors 65, it is possible to check the stock present in the reserves 56 of the different modules of the display unit, and thus to confirm the overall stock present in the display unit. For this purpose, an infrared sensor can be used, for example. This allows the size available in the storage space 56 to be known, the processing unit 72 knowing which product support 52 is present on the module 36, it can download the space taken up by the product(s) present in the stock behind the product support 52 from the server 14 and so will be able to calculate the amount of stock remaining. This makes it possible to assess the requirements for the brand.

Alternatively, a camera-based product recognition, as described in U.S. Pat. No. 10,643,270, is implemented to avoid the use of an infrared sensor.

Sending Promotional Offers to the Customer when They Interact with the Display Unit

These interactions may include one or more of: Drawer opening, drawer closing, product recognition on a dedicated area, facial recognition on a dedicated area.

The display unit 12A allows the brand to manage the consequences of a customer's actions on the display unit as described above. For example, the brand can trigger the displaying of specific promotional content when a drawer is opened.

Advantageously, the display unit performs facial detection using the system 94 and displays content specific to the detected customer, for example according to demographic factors (age, gender, mood of the consumer).

If true facial recognition is performed, information dedicated to a specific customer can be sent to the consumer when interacting with the display unit. Of course, this information will be correlated with the products on the product support or the products in the local network. The customer database can be downloaded from an external server (e.g. server 14) and will be linked to the brand's customer relationship management software. It goes without saying that the software will respect the privacy rules set out in local legislation and will also be aligned with the terms and conditions to which the customer has subscribed via the brand's CRM software.

Control by Button 40 or Interface 46 to Check a “Planogram”

The processing unit 72 of the modules may embed wireless networks such as Bluetooth or wifi for example. This allows for user control of the display unit at the point of sale. For example, one of the screens 76, 76A of the display unit instructs the user to connect to a local wifi network. Once logged in, the user scans the QR code 96 displayed by the display unit and is redirected to a local web page (not shown) allowing that person to manage the display unit. This also allows the management of a “planogram” by the staff at the point of sale. This opens up a range of possibilities for the brand to make the point of sale interactive for the customer while linking this to the products 32 on the display unit(s).

With the features described above, the display unit 12A ensures that the video information displayed, for example a sales price, actually corresponds to the sample products 54 displayed. This facilitates the implementation of the “planograms”.

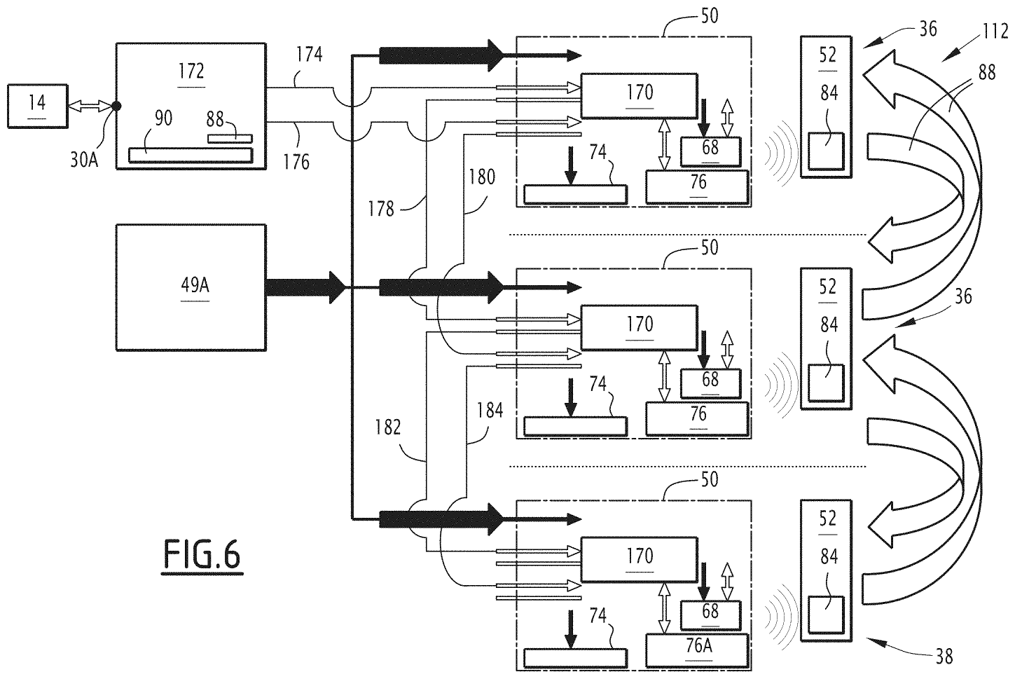

With reference to FIG. 6, a display unit 112 according to a second embodiment of the invention will now be briefly described. The display unit 112 is similar to the display unit 12A shown in FIGS. 1 to 5. Similar items have the same numerical references and will not be described again. Only the differences will be described in detail below.

The modules 36 and the module 38 of the display unit 112 do not have individual, decentralised processing units 72, but advantageously a video management chip 170.

The chip 170 of one of the modules 36 (located at the top of FIG. 6) is connected to a single central unit 172 of the display unit 112 by an incoming video cable 174, and advantageously by an incoming position cable 176.

The chip 170 of the module 36 in the centre of FIG. 6 is connected to the chip 170 of the top module 36 by a video cable 178, and advantageously by a position cable 180.

Likewise, the chip 170 of the module 38 (at the bottom of FIG. 6) is connected to the chip 170 of the centre module 36 by a video cable 180, and advantageously by a position cable 182.

Thus the modules 36, 38 of the display unit 112 are connected to each other in a cascade pattern.

The processing unit 172 of the display unit performs the same functions with the chips 170 as each of the processing units 72 of the display unit 12A. The chip 170 allows the transfer of video as well as commands from the processing unit 172 via a serial computer protocol.

The position cables perform the same functions as the positioning system 44 of the display unit 12A and also allow the sending of information allowing the management of use cases specific to the module 36. For example, if the module 38 has a product 54 which is no longer in the field of vision of the camera 92, this information will be sent to the processing unit 172, which processes that information thanks to the processor 88 and checks whether a command specific to that application exists in the use case management software stored in the memory 90, which indicates that a module 36 in position C2-L2 should be switched on. Therefore the processing unit 172 sends the command to the top module 36 via the position/command cable 176.

The display unit 112 operates in a similar way to the display unit 12A, except that the “smart” functions are concentrated in the processing unit 172, relayed by the chips 170.

The display unit 112 offers the same advantages as the display unit 12A. However, its serial architecture reduces hardware costs. Nonetheless, it is important to note that this architecture implies a greater number of cables and therefore a more complex installation, which may imply a higher installation cost.

1. A sales display unit adapted to present one or several product(s) and to advertise the product(s) at a point of sale, the display unit comprising at least one module for presenting at least one set of products, the display unit comprising a frame, at least one processing unit comprising a processor and a memory, the module comprising:
optionally a reserve containing a stock of said set of products,
a receptacle mounted on the frame and comprising a detection member, and
a product support comprising an identification member representative of the product support, the product support being movable between an uninstalled position, in which the product support is away from the receptacle, and an installed position, in which the product support is received in the receptacle,
the detection member 68 being adapted to cooperate with the identification member, when the product support is in the installed position, in order to identify the product support, and to send to the processing unit information representative of the identified product support being in the installed position,
the memory comprising information which, when executed by the processor, causes the processing unit to send information contained in the memory to a server via a network, and/or to a screen of the display unit, the information sent relating to at least the set of products associated with the identified product support.

2. The display unit according to claim 1, wherein the product support comprises at least one sample product associated with the product set.

3. The display unit according to claim 1, wherein the product support comprises at least one display product associated with the product set.

4. The display unit according to claim 1, wherein the identification member comprises:
a radio tag,
a QR code, or
an analog electrical circuit.

5. The display unit according to claim 1, wherein the memory further comprises information which, when executed by the processor), causes the processing unit to:
read at least one piece of information from the memory, and send the read piece of information to the server, the read piece of information being related to the set of products associated with the identified product support, or representative of the identified product support being in the installed position, or
send a request to the server for information about the set of products associated with the identified product support, and/or for configuration information of the processing unit, receive said information, and write it into the memory.

6. The display unit according to claim 1, further comprising:
at least one sensor adapted to perform a facial detection of a user of the display unit, or
a sensor for tracking said stock by visual recognition of the products in said stock.

7. The display unit according to claim 1, wherein the receptacle comprises a fixed part integral with the frame, a drawer movably mounted on the fixed part, and a sensor adapted to detect an opening or closing of the drawer and to send information representative of the opening or closing to the processing unit.

8. The display unit according to claim 7, wherein the memory comprises information which, when executed by the processor, causes the processing unit to:
read new information contained in the memory, and send the new information to the screen, the new information being related to the product set associated with the identified product support, or
send the server information representative of the opening or closing.

9. The display unit according to claim 1, comprising:
a geolocation system adapted to geolocate the display unit and provide the processing unit with geolocation information, or
an interface allowing a user of the display unit to provide the processing unit with geolocation information.

10. The display unit according to claim 1, further comprising a button connected to the processing unit, the processing unit being configured to display on the screen information representative of the display unit when the button is operated by a user of the display unit.

11. The display unit according to claim 1, comprising a plurality of modules for presenting a plurality of product sets, each of the modules comprising:
optionally a reserve containing a stock of said set of products,
either a decentralised processing unit comprising a processor and a memory, or a video management chip connected to the centralised processing unit of the display unit,
a screen connected to the decentralised processing unit or to the chip,
a receptacle mounted on the frame and comprising a detection member, and
a product support comprising an identification member representative of the product support, the product support being movable between an uninstalled position, in which the product support is away from the display unit, and an installed position, in which the product support is received in the receptacle,
the detection member being adapted to cooperate with the identification member, when the product support is in the installed position, in order to identify the product support, and to send to the decentralised processing unit or the processing unit of the display unit information representative of the identified product support being in the installed position,
the memory of the decentralised processing unit or of the processing unit of the display comprising information which, when executed by the processor of the decentralised processing unit or of the processing unit of the display unit, leads the decentralised processing unit or the processing unit of the display unit to send video information contained in the memory to the screen, the video information relating to the set of products associated with the identified product support.

12. The display unit according to claim 11, further comprising an intercommunication system of the modules adapted so that the decentralised processing units or the processing unit of the display unit receive positioning information:
representative of the relative position to each other of receptacles having product supports in the installed position, or
for each of the receptacles having product supports in the installed position, representative of the product supports that are in the installed position in those of the receptacles located in a predefined vicinity of said each of the receptacles.

13. The display unit according to claim 12, wherein the memory of the processing unit of the display unit or of at least one of the decentralised processing units comprises information which, when executed by the processor of the processing unit of the display unit or of the at least one of the decentralised processing units, leads the processing unit of the display unit or the at least one of the decentralised processing units to:
send the server the positioning information, or
send synchronised video information to some of the screens.

14. The display unit according to claim 12, wherein the memory of at least one of the decentralised processing units associated with one of the receptacles comprises information which, when executed by the processor of the at least one of the decentralised processing units, causes the at least one of the decentralised processing units to:
send information to another of the decentralised processing units, or
send the screen associated with it information relating to one of the product sets associated with one of the product supports received in another of the receptacles.

15. The display unit according to claim 1, wherein the products are cosmetics.

16. A method of displaying one or more products at a point of sale in order to advertise the product(s) at the point of sale, using a display unit according to claim 1, and comprising the following steps:
moving the product support from the uninstalled position to the installed position,
cooperation of the detection member with the identification member to identify the product support, and to send to the processing unit information representative of the identified product support being in the installed position,
reading, by the processor, of information from the memory, and
sending, by the processing unit, of information from the memory to the server via the network, or to the screen, the information relating at least to the set of products associated with the identified product support.

17. The method according to claim 16, wherein the products are cosmetics.
